(19) United States
(12) Patent Application Publication
(10) Pub. No.: US 2026/0214779 A1
(43) Pub. Date: Jul. 23, 2026

(54) SYSTEM AND METHOD FOR PROCESSING OR JOINING MATERIALS AND THEIR THEIR APPLICATION

(71) Applicants: WEA TECHLAB SPOLKA Z OGRANICZONA ODPOWIEDZIALNOSCIA, Dabrowa Gornicza (PL); EUROTEK INTERNATIONAL SPOLKA Z OGRANICZONA ODPOWIEDZIALNOSCIA, Warszawa (PL)

(72) Inventors: Ernest SZAJNA, Wojkowice Koscielne (PL); Miroslaw TUPAJ, Rzeszow (PL); Jozef DRESNER, Warszawa (PL); Karol LYSIAK, Jawornik Polski (PL); Anna TRZCIONKA-SZAJNA, Wojkowice Koscielne (PL)

(21) Appl. No.: 19/139,197

(22) PCT Filed: Dec. 6, 2023
(86) PCT No.: PCT/PL2023/000060

§ 371 Date: Jun. 13, 2025

(30) Foreign Application Priority Data
Dec. 13, 2022 (PL) P.443136

(51) Int. Cl. H05H 1/42; B23K 26/12; B23K 26/144; B23K 26/211; B23K 26/34; C21D 1/09; C22B 9/22; C22C 33/04; C23C 24/10

(52) U.S. Cl. CPC H05H 1/42; B23K 26/12; B23K 26/144; B23K 26/211; B23K 26/34; C21D 1/09; C22B 9/226; C22C 33/04; C23C 24/103

(57) ABSTRACT

A system for processing or joining materials comprises a radiation source (L) generating a beam of radiation with flux density that allows to obtain a change in the form or physical properties of the given material, and directing this beam at the treated material (1). The system has at least one source of cold atmospheric plasma—CAP (A, A1, A2, B, B1, B2) directing the CAP stream (9) to the area of material (1) exposed to the beam from the radiation source (L), or partially or entirely onto a trace (2) of treatment. The CAP source (A, A1, A2, B, B1, B2) has an adjustment of distance (d1, d2) of the nozzle (8) outlet from the treated surface of material (1) and is positioned coaxially with the radiation beam or inclined to this beam.

The subject of the invention is a system implementing the process of laser processing of materials in a plasma atmosphere. Material processing can be surface—e.g. cladding, alloying, dispersing or remelting, it can also be heat treatment, thermo-chemical treatment, as well as welding. The invention also relates to a method for carrying out said process using the invented system and their application.

Laser devices are used e.g. in the processes of welding, cladding, alloying, dispersing, surface melting, cutting, drilling, surface heat treatment, surface cleaning of material surfaces, texturing or laser ablation. The efficiency of the laser process depends primarily on the energy absorption of the laser beam by the processed material, because the laser radiation is intensely reflected, depending on the type of processed material, its surface condition and the angle of exposure to the laser beam.

In order to increase the efficiency of welding processes, arc welding methods are used to support the operation of the laser.

There are known hybrid processes of the material processing, in which the main factor influencing the welding processes is the laser beam, associated with an additional source of heat. In practice, an electric arc is used as an additional source of heat using one of three techniques: electric welding with an infusible tungsten electrode in an inert gas shield (Gas Tungsten Arc—GTA) [1], electric welding with a fusible electrode in a shield of the inert and active gases (Gas Metal Arc—GMA) [2], and plasma welding (Plasma Arc Welding—PAW) [3,4].

In each of these heat sources, one deals with arc plasma of various levels of ionization, where the temperature ranges from several thousands to tens of thousands of degrees Celsius. The combination of the laser beam with the arc plasma stream has a synergistic effect, consisting in heating the surface of the material and increasing the absorption of laser radiation [5]. In addition, laser arc welding improves the stability of the electric arc, increases the depth of penetration and enables an increase in welding speed compared to the electric arc alone [6,7].

In the case of hybrid, i.e. laser-arc welding of thin sheets without additional filler, the size of the welding gap can be increased by tens of percent of the material thickness, and remelted zones are characterized by a lower hardness value and larger dimensions, and a larger heat affected zone, compared to the laser welding alone [8].

Hybrid processes are more efficient than individual laser and arc processes. For example, the use of the CO2 laser and the GTA method increased the thermal efficiency of the process by 17%, compared to the total thermal efficiency of each of the individual methods [9].

Mechanisms for enhancing plasma treatment (electric arc plasma) by a laser are known, including:
the influence of the laser on the discharge parameters by changing the arc resistance, stabilization and contraction of the discharge;
change in the composition of the plasma as a result of introducing into the arc the discharge of atoms coming from the evaporation of the irradiated material.

The main disadvantage of the hybrid laser-arc methods presented above is that the electric arc heats a large volume of the processed material, which can lead to adverse chemical and structural changes propagating beyond the treated zone of material. In addition, the generation of an electric arc is very energy-intensive, and this in the era of rapidly increasing energy prices leads to a significant increase in production costs.

The use of a plasma source other than an arc plasma source for laser processing does not solve the problem of high temperature and high energy expenditure. For example, French patent application FR2715942 A1 relates to coating of components by laser melting of powders. According to the process disclosed therein, it consists of surface treatment of a substrate by deposition of a coating obtained by the laser beam melting of at least one powder carried in a flow of neutral gas inside a plasma torch. The device consists essentially of the plasma torch and has a laser equipped with an optical system. The plasma torch generates a plasma stream oriented at 45 degrees with respect to the laser. It is fed by hot and by cold sources of neutral gas. Cold gas surrounds a core of hot plasma, and the temperature of plasma is comprised between 2000 and 3500 degrees Celsius, preferably between 2800 and 3500 degrees Celsius. The powder or a mixture of powders is injected into the flow of hot neutral gas and melts therein. The jet of molten powder carried by the plasma flow is oriented at 45 degrees towards the impact zone of the laser beam. Neutral gas is argon or helium.

The technical problem faced by the authors of the invention is to modify the technology of laser material processing in such a way that the elimination of energy-intensive, hot plasma does not result in deterioration, but on the contrary-improvement of the process parameters.

The inventors drew attention to a low-temperature plasma (nonthermal plasma—NTP, non-equilibrium plasma, commonly called cold plasma), and in particular to a cold atmospheric plasma (Cold Atmospheric Plasma—CAP). Cold plasma requires less energy to produce it, and although the degree of gas ionization in it is much lower than in the hot plasma, it turns out to be sufficient in many applications, e.g. medical or as a sterilizing agent, which is discussed below. The inventors decided to develop a laser-plasma system using cold plasma in order to check whether the obtained results are satisfactory.

Cold atmospheric plasma (CAP) is a partially ionized gas. The bio-modulating, stimulating, disinfecting and sterilizing properties of CAP are used in medicine, food technology, and environmental protection. It is also used in industry in the treatment of metal and plastic surfaces (cleaning, activating, etching of surfaces, removing of layers), for modifying surfaces, coating and applying thin layers. It is used to change surface properties (e.g. wettability, adhesion, hardness, scratch resistance, permeability, corrosion resistance).

Low-temperature plasma remains in a state of thermodynamic non-equilibrium, because temperature of free electrons which is of the order of a thousand or several thousands kelvins, is many times higher than temperature of ions in the gas, which can be as low as about 400° C., or even a room temperature. This allows the CAP to be a cooling agent. In order to avoid confusion, in the following embodiments of the invention two different terms for temperature are used: electron temperature and ionic temperature.

It should be emphasized that the term “atmospheric plasma” does not mean a ionized air, but a selected working gas ionized at atmospheric pressure, i.e. pressure prevailing in the area where this plasma is generated and used. This is usually pressure close to the normal one. The ionization of the working gas is carried out using high-frequency (HF) radio waves.

From the Korean patent KR101843371B1, a device for machining is known, containing, among others, a laser source and a plasma module that generates cold plasma. This plasma serves only for cooling the cutting tool and replaces the commonly used coolant in the machining process assisted by laser heating of the machined surface. The cold plasma used here does not directly affect the treated surface.

In turn, from the Chinese patent description CN102601677A, there is known a method in which a stream of cold atmospheric plasma is used as a lubricating and cooling medium in the substrate cutting. The cutting tool and the substrate material are surrounded by a stream of cold atmospheric plasma at room temperature or slightly above. According to the authors of the invention, the method of cutting assisted by a stream of atmospheric cold plasma is environmentally friendly, it allows to obtain the effects of lubrication and cooling of various metal and non-metallic materials, reducing the cutting force, extending the lifetime of the cutting tool, and improving the quality of the cutting surface.

In the proposed system for the implementation of the hybrid process of processing materials, the laser as a radiation source is synergistically combined with the CAP source. The laser can work continuously or pulsed, generating wavelengths from 200 nm to 15 μm (micrometers). The term “laser” or “radiation source” shall be understood here in general as any source of radiation generating a beam of radiation with flux density enabling a change in the form or physical properties of the irradiated material, in particular a source of electromagnetic radiation, especially a source of coherent radiation such as the aforementioned laser or a laser diode. In this context, the use of the term “laser-plasma” in the description of the invention does not limit the invention to the use of a laser, but is intended to direct the person skilled in the art to the family of the material processing methods discussed in the introduction. It should be emphasized that the source of radiation can also be a source of corpuscular radiation, e.g. a linear accelerator.

The system uses at least one stream of cold atmospheric plasma (CAP), frequency-generated by means of radio waves or microwaves. Partial gas ionization takes place under atmospheric or reduced pressure. The gas stream is focused on the surface of the processed material, in the area exposed to appropriately focused laser beam.

The new system and process described here synergistically combine the effects of laser and cold plasma (Synergy of Laser and Cold Plasma—SLCP) and thus significantly differ from the hybrid solutions described in the introduction. The difference lies in the use of an influence of CAP on both the surface and the internal structure of the processed material. This allows to obtain in one machining process the benefits unattainable in the previously applied processes of hybrid material processing. These advantages are in particular:
a) perfect cleaning of the workpiece surface in a treated zone directly before processing;
b) protection of the treated zone against oxidation;
c) reducing the minimum amount of energy necessary to carry out the treatment;
d) reduction of both stresses and size of the heat-affected zone (as a result of reducing the amount of heat introduced into the treatment zone);
e) enabling modeling of the microstructure depending on the application (larger grains may be advantageous in the case of increasing the resistance of the treated zone to high temperature creep);
f) change in the structure of the surface zone of the processed material, removing stresses and reducing grain size, modifying and stabilizing the microstructure (possibility of eliminating heat treatment),
g) facilitating, and in the case of some materials, enabling the surface treatment of materials, consisting in cladding, alloying and dispersing of the surface with the use of metallic, metal-ceramic or ceramic powders, and processes of surface heat treatment, thermo-chemical treatment, surface structuring or laser ablation.

The invention uses the known and mentioned above cooling properties of CAP, preventing overheating of the processed material. It was also found that the thermodynamically non-equilibrium nature of the CAP allows, on the one hand, to chemically isolate the treated area from the ambient atmosphere, as the ionized gas is close to thermodynamic equilibrium with the environment, and on the other hand, to prevent dissipation of the laser beam energy into the environment, because hot electrons are in thermodynamic equilibrium with infrared radiation of a laser beam. In other words, by applying the CAP in the processing area a hot zone resembling a black body for thermal radiation is formed, which at the same time is cold (transparent) for higher energy radiation (visible light, UV). It follows that the proper selection of CAP parameters may affect the final effects of the process conducted with the use of the SLCP system.

Carrying out the SLCP process requires the use of a system that allows for the appropriate configuration of one or more CAP streams in relation to the laser beam.

The system according to the invention for processing or joining materials includes a radiation source generating a beam of radiation with flux density enabling to obtain a change in the form or physical properties of a given material, and directed at the processed material. The system has at least one source of cold atmospheric plasma (CAP) directing its stream to the area of the material exposed to the beam from the radiation source, or partially or entirely to the trace of the treatment. The CAP source is also called the CAP head. Cold atmospheric plasma can be generated, for example, by microwaves or HF radio waves causing at least partial ionization of the gas.

In the description of the invention, it was assumed that the term “ahead” means “towards the direction of movement of the radiation source relative to the material, measured from the beam emitted by the source”, and the term “behind” means the opposite side. It shall be obvious to those skilled in the art that relative motion is concerned, i.e. the radiation source together with other components may move relative to a stationary workpiece, or the workpiece may move relative to a stationary source. It shall also be obvious that in particular embodiments both the radiation source and the treated material can move relative to the environment. Such a solution may be beneficial, for example, for surface treatment of tubular objects (e.g., the pipe is rotated while the system performs a linear movement, similar to that in a typical lathe).

Using the invented system one can process the material spotwise, without imposing its movement relative to the material. Then, the above-introduced terms “ahead” and “behind” are equivalent, i.e. the CAP head (one or more) can be located in any position relative to the radiation source. On the other hand, if the relative motion of the radiation source relative to the material is set, the trace of treatment is created on the material during processing, e.g. a weld or a melting spot. The CAP head (again, one or more) can then be placed ahead the radiation source with a plasma stream directed at the area irradiated by the radiation beam, or behind the radiation source with the plasma stream directed partly at this area and partly at the trace, or only at the trace of the treatment behind the area exposed to the radiation beam. It is possible to combine in one process all variants mentioned above, e.g. in the machining carried out in sections.

In first preferred embodiment of the invention, the CAP source is mounted coaxially with the radiation source and has an adjustment of distance of the nozzle outlet from the surface of the treated material. If the radiation source generates a substantially parallel beam, such as a laser or a laser diode, there is no need to adjust the distance between the CAP source and the radiation source and the two may be coupled together. The CAP plasma stream is coaxial with the radiation beam and surrounds it, therefore the entire area of impact of the radiation beam on the material is surrounded by plasma, and the area covered by plasma on the material has an approximately circular cross-section.

In second preferred embodiment of the invention, the axis of the CAP source is oblique in relation to the axis of the radiation beam and has an adjustment of the distance of the nozzle outlet from the treated surface of the material, and an adjustment of the angle between the axis of the nozzle and the surface of the material, and preferably also an adjustment of distance from the radiation source.

Both of the above embodiments can be implemented in the same system.

An embodiment of the system intended for welding has a welding wire feeder. In turn, in the embodiment intended for cladding or dispersing, the system has a powder feeder, in particular a feeder of the metal powder, ceramic powder or a mixture of these powders.

The claimed system also provides for installation of an optional feeder of additional material, in particular in the form of powder or gas (e.g. shielding gas) or liquid.

In a preferred embodiment of the system, one or more feeders, i.e. a welding wire feeder and/or a powder feeder and/or an additive material feeder, are mounted in the feeding head. Placing individual feeders in the feeding head stabilizes the system mechanically, inter alia damping the vibrations generated during generation of the CAP stream.

CAP sources may also be mounted in the feeding head, in particular the CAP source set coaxially with the radiation source, i.e. when the axis of the plasma stream generated by the CAP coincides with the axis of the radiation beam. In this case, it is recommended to integrate the three elements of the system: the radiation source, the CAP head, and the feeding head, in order to increase the mechanical stability and miniaturization of the system, and to facilitate control over the process.

Between the radiation source and the material, above the feeding head or in the feeding head itself, a system focusing and guiding the radiation beam is mounted. It is recommended that this system be equipped with the control of distance from the surface of the material to be machined. In particular, when the radiation source is a laser, in particular a disk laser or a laser diode, the system for focusing and guiding the radiation beam is an optical system, preferably equipped with an optical fiber.

Alternatively, instead of an optical fiber, the course of which can be arbitrary, an optical channel can be used, e.g. in the form of a tube, the axis of which must coincide with the axis of the radiation beam. The optical fiber or the optical channel is guided through the delivery head.

In the implementation of the system, in which the plasma stream from the CAP source is coaxial with the light beam generated by the radiation source, the optical system adjusts the diameter of the light beam to the entrance aperture of the optical fiber or optical channel, which may begin even before the CAP source and continue along the axis of the CAP source and out of the nozzle forming the plasma jet, close to the workpiece. The optical fiber or optical channel may be shorter and not extend beyond the CAP source.

The role of the optical fiber or optical channel is to separate the light beam from the plasma stream, thus preventing from the light scattering from this beam.

The optical system adjusting the light beam to the optical fiber or optical channel may consist of a focusing lens and a diffusing lens with opposite values of optical power. By changing the distance between these lenses one can obtain a beam of light with required cross-sectional diameter.

If a thermal impact on the treated material is desired, the source of radiation is an infrared radiation source, preferably with a wavelength of 1064 nm. The radiation source can produce a beam of light with a wavelength between 200 nm and 15 μm.

The key elements of the system, i.e. the radiation source together with the system focusing and guiding the radiation beam, the CAP head or heads and the feeding head can be mounted on a robotic arm, preferably numerically controlled and executing a programmed machining process.

The system described above enables the implementation of a method of processing or joining materials, in which a beam of radiation is directed at the treated material from a radiation source, with flux density that allows for a change in the form or physical properties of this material, wherein by means of at least one CAP source a stream of cold atmospheric plasma is generated and directed at the area of the material exposed to the beam from the radiation source, or partially or entirely at the trace of the treatment.

According to this method, the CAP source is mounted ahead of the radiation source or coaxially with it, and a stream of cold atmospheric plasma is directed onto the area of the material exposed to the beam from the radiation source. If relative movement of the system and material is initiated, the system leaves behind a trace of machining during machining process. Preferably, the CAP source is also mounted behind the radiation source and a stream of cold atmospheric plasma is directed onto the area of the material exposed to the beam from the radiation source, or partially or entirely onto the trace of the treatment behind the radiation source. Also distance of the nozzle outlet from the treated surface of the material and the angle between the axis of the nozzle and the surface of the material are set.

The system and method described above are applicable to the treatment or joining of metallic, non-metallic or composite materials, in particular to carry out welding, cladding, alloying, dispersing, surface remelting or surface heat treatment using a radiation source, preferably an infrared radiation source.

The system according to the invention is shown in various embodiments in the figures, where:

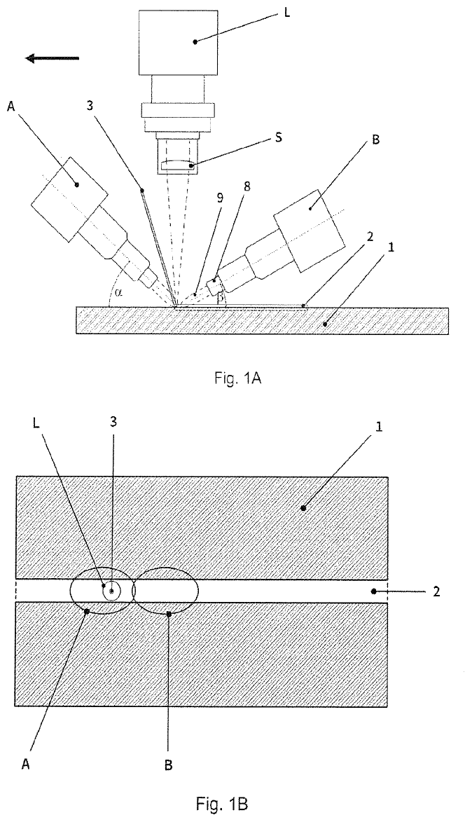

FIG. 1A shows schematically the SLCP system and its operation;

FIG. 1B shows spatial distribution of the working beams on the workpiece;

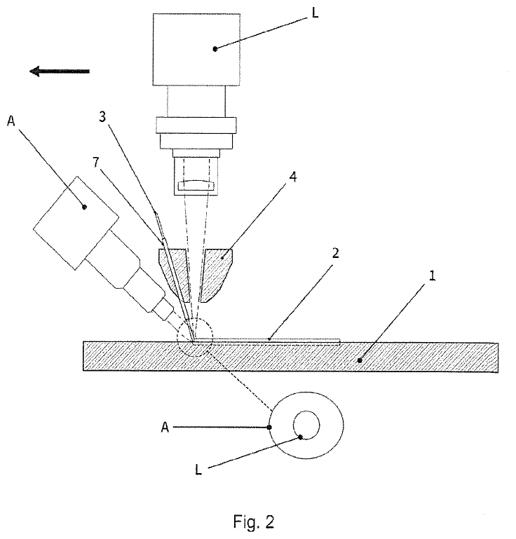

FIG. 2 illustrates the system with one CAP head positioned ahead the laser beam, with adjustable tilt angle and distance to the laser head and to the material, with a head for wire welding mounted, and with one wire feeder;

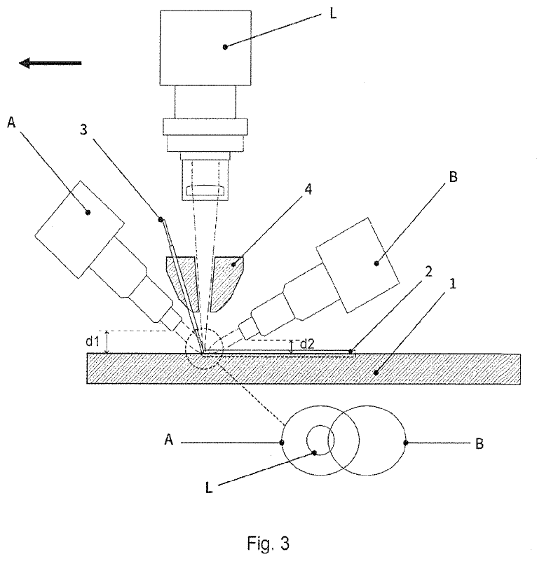

FIG. 3 shows the system as in FIG. 2, with second CAP head positioned behind the laser beam;

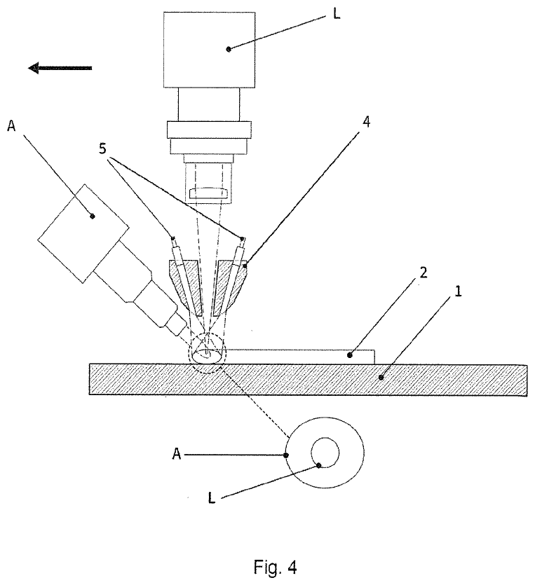

FIG. 4 shows the system as in FIG. 2, but with mounted head for powder cladding, with two powder feeders;

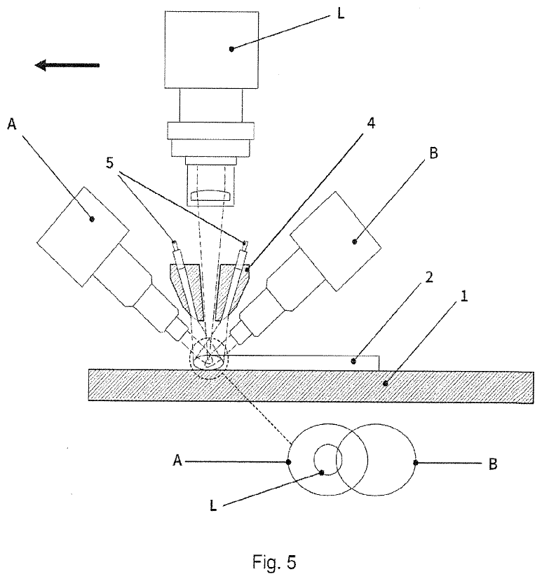

FIG. 5 illustrates the system as in FIG. 4, with second CAP head placed behind the laser beam;

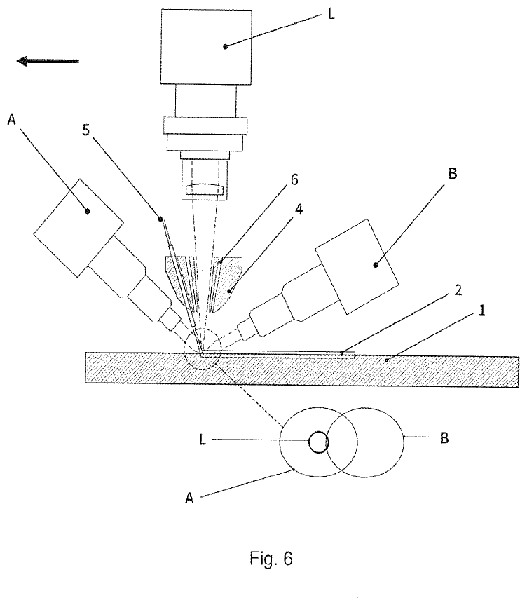

FIG. 6 shows the system as in FIG. 5, but with a universal head for wire welding, powder cladding or additional material feeding;

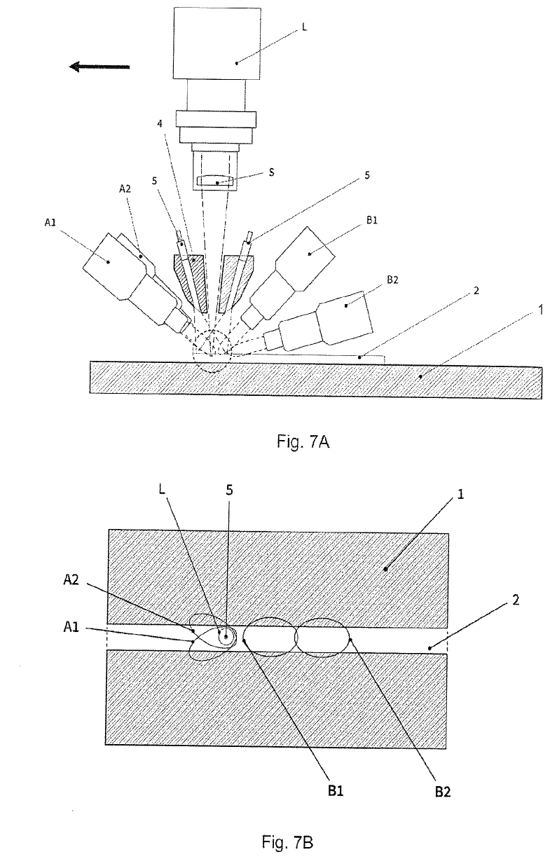

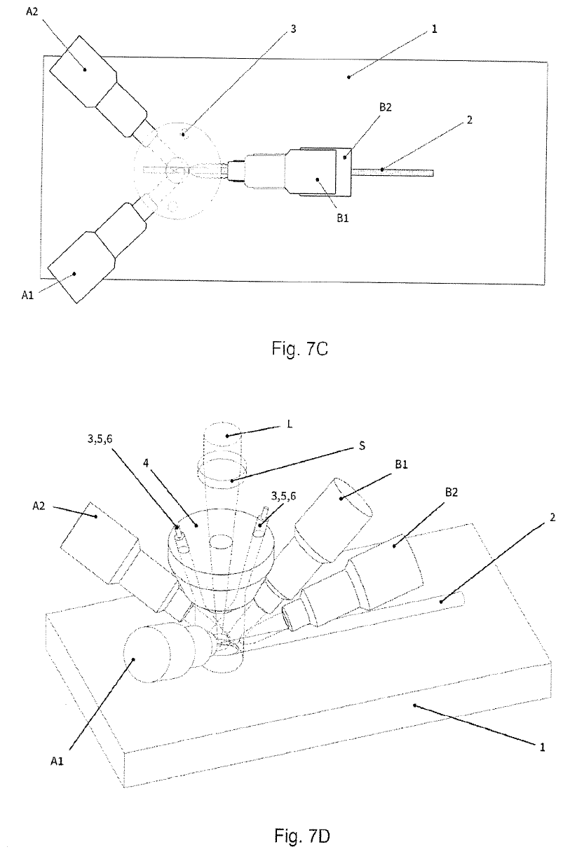

FIG. 7A shows side view of the SLCP system with four CAP heads, with a head for powder cladding and two powder feeders;

FIG. 7B shows the spatial distribution of the working beams on the workpiece in the arrangement of FIG. 7A;

FIG. 7C shows the system as in FIG. 7A in top view;

FIG. 7D shows a perspective view of the system as in FIG. 7A, with universal feeders for wire, powder or other additional material;

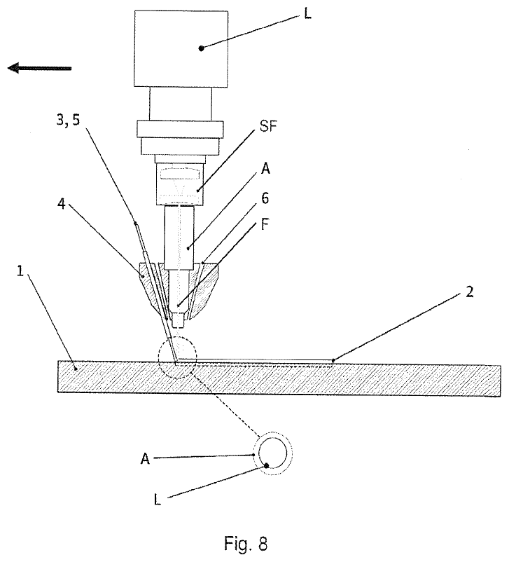

FIG. 8 illustrates the system with one CAP head coaxial with the laser beam, with adjustable distance to the material, with mounted universal head for wire welding, powder cladding or feeding additive material;

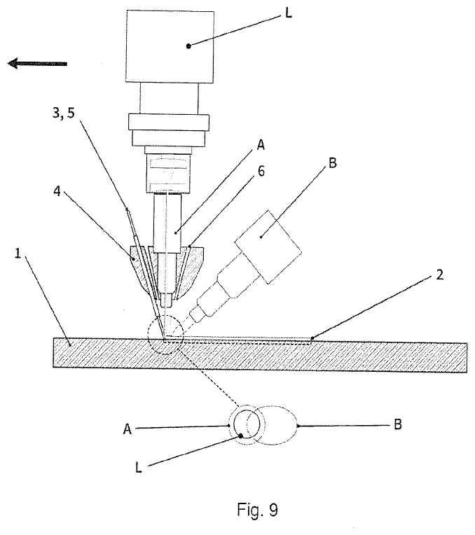

FIG. 9 shows the system as in FIG. 8, with second CAP head positioned behind the laser beam;

FIG. 10 illustrates the jets of cold atmospheric plasma, with the laser turned off;

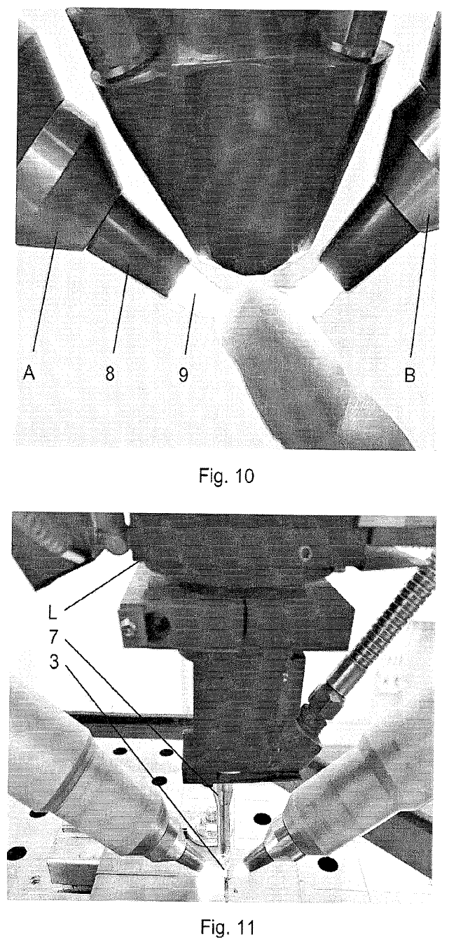

FIG. 11 shows the SLCP system in a wire welding configuration at the beginning of the welding process;

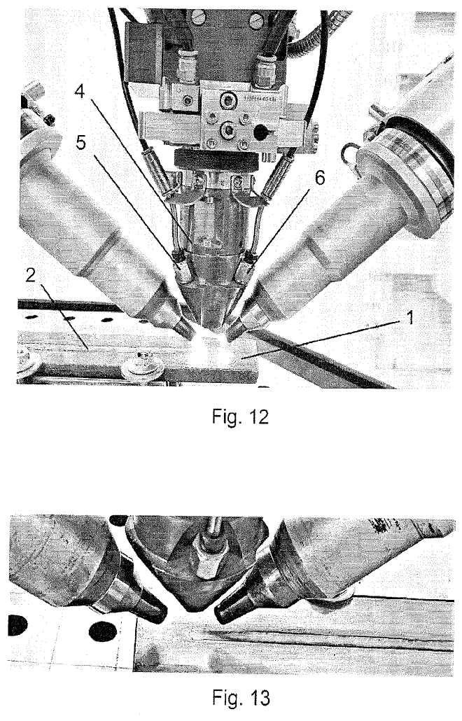

FIG. 12 shows the effect of the alloying process using the SLCP system;

FIG. 13 shows the trace structure on the substrate material subjected to melting, after completing the process; the signs of melting after solidification in the stream of cold plasma fed from the right CAP head are visible;

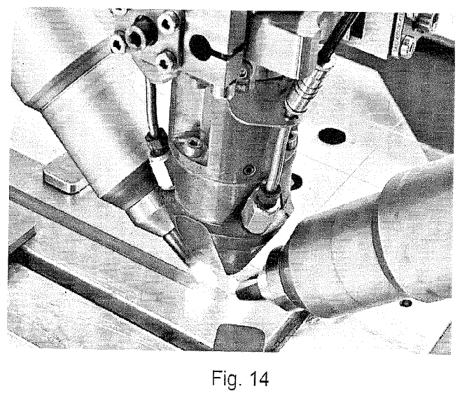

FIG. 14 shows the trace of the surface heat treatment, without signs of melting of the substrate surface.

In the embodiments of the SLCP system and method, the synergy consists in the interaction of the light beam from the laser L and at least one jet 9 of cold atmospheric plasma generated by the CAP sources (A, B) and emitted by the nozzles 8, as schematically shown in FIG. 1A. The sources of all the beams are mounted on the robot arm and jointly moved relative to the treated material (workpiece) 1 according to the direction shown by the arrow in the drawings. The filler or other additional material, e.g. a shielding gas, is supplied in the form of welding wire 3, metallic, metal-ceramic or ceramic powder 5, or in another form 6. A trace 2 remains on the material 1 after processing.

Additional material feeding devices (e.g. wire feeder 7) are mounted in the feeding head 4. The role of the feeding head is to stabilize the key components of the system during operation, what ensures full control over the process. It is possible in special cases to run the process in a simplified version of the system without the feeding head, as shown in FIG. 1A and FIG. 11, but in general it is not recommended.

Convergence of the laser beam is set using the optical system S. The beam can be focused on the treated material and then the treatment is executed in spots (pulsed) or linearly, depending on the type of movement performed by the robot arm programmed in the system. Alternatively, the focus of the laser beam can be positioned above or below the surface of the material, and then the energy of the beam is distributed over a larger area, which leads to reduction of flux density and lowering the process temperature.

Alternatively, a system that changes the beam aperture may be used, e.g. a two-lens optical system SF consisting of a converging lens transforming a parallel beam into a converged beam, and a diverging lens of opposite optical power, restoring parallel path of the beam. Changing the distance between these lenses allows to adjust the diameter of the beam.

Additionally, the system can be equipped with a device that ensures a constant distance between the feeding head 4, the laser L and the CAP heads from the processing site, what enables processing of surfaces of any curvature, with edges, bends, etc. In a simplified version, the device continuously measures the robot arm distance from the surface of the material and corrects it accordingly. In a more advanced embodiment, a digital map of the surface is created and the arm movement is programmed in three dimensions (3D).

FIG. 1B shows vertical projection on a plane tangential to the surface of the material at the processing site, with marked areas of exposure to the laser beam L, plasma beams A and B, and the place of of the filler application (here: welding wire 3). The position of areas A and B of the material exposure to plasma relative to the area of exposure to the laser beam is adjusted by angular orientation (angles α and β in FIG. 1A) and translation of the position of the CAP heads. In the example shown, the plasma beam A surrounds the focus area of the laser beam. The plasma beam B from the second CAP head is moved behind the area of the plasma beam A and the laser beam L, protecting the previously treated hot area. This figure shows the case of a slight defocus of the laser beam, so the tip of the welding wire falls entirely within the area of exposure to laser radiation.

In this configuration, the effect of the CAP in area A is different than the effect of CAP in area B. Plasma A has a beneficial effect on the properties of the treated area of the material, supporting the laser process, while plasma B provides a shield against oxidation of the processed material immediately after the process.

In a processes requiring higher energy/density of the plasma stream, e.g. in the case of welding of materials with a thickness of several millimeters, a partial or entire overlapping of both plasma streams A and B and of the laser beam is applied. It is also possible to add a third CAP head in the configuration: two CAP heads ahead and one CAP head behind the treatment zone. Then, two plasma beams support the laser operation, and the third beam is used to protect the material after processing.

In the proposed invention does not limit the number of CAP heads is not limited. For example, if the process needs to extend the post-process protection area, two or more CAP heads can be placed behind the laser beam. An example of the system with four CAP heads—two (A1 and A2) ahead and two (B1 and B2) behind the treatment zone—is shown in FIGS. 7A, 7B, 7C and 7D.

FIG. 2 and FIG. 3 show exemplary configurations of the SLCP system for conducting welding and cladding processes, with the use of a laser head for welding with a welding wire, with application of one (FIG. 2) or two (FIG. 3) CAP streams. In these and subsequent configurations, the plasma beam A supports the laser process, and the optional plasma beam B is used for post-process protection.

FIG. 4 and FIG. 5 in turn show configurations of the SLCP system for conducting the welding process of thin materials, the edges of which do not require bevelling (after turning off the powder feed), or for surface treatment in the process of surface remelting of materials, depositing overlays, alloying the surface of materials (using metallic powders), surface dispersing of materials (using ceramic powders) and surface thermal and thermo-chemical treatment, structuring and laser ablation. In these embodiments, a laser head for powder cladding is used, with one or two CAP streams applied.

A development of the variant of FIG. 5 is shown in FIG. 6. In this case, the system performs a combined application of different additional materials onto the treated surface, for example of the welding wire and ceramic powder.

FIG. 8 and FIG. 9 show exemplary implementations of the system in which one CAP source is set coaxially with the laser. The light beam emitted by the laser passes through the optical system of lenses SF, which adjusts its cross-section to the input aperture of the optical channel or optical fiber F. This optical channel or optical fiber passes through the CAP source, specifically through its nozzle 8, so that the beam of light irradiating the material is enveloped by the stream 9 of cold atmospheric plasma. The optical fiber F may be placed inside the optical channel to prevent leakage of light from fiber to plasma. in this arrangement the optical channel shields the optical fiber. Additionally, another CAP source can be positioned behind the beam, as shown in FIG. 9, and also an additional (supporting) CAP source ahead the beam, likewise in FIG. 7A.

### System—Example 1

The method of conducting the process in first embodiment of the system shown in FIG. 2 consists in using a welding robot arm with mounted laser head L for welding with wire 3, welding wire feeder 7, and head A of cold atmospheric plasma. The CAP head is mounted ahead the laser beam and has an adjustable angle α of inclination of its axis relative to the treated material, as well as an adjustable distance from the laser and the distance d1 from the surface of the material. This allows for focusing the CAP stream on the surface of the processed material 1 in the area of exposure to the focused laser beam, which is directed approximately perpendicularly to the surface of the material. In this case, the angle α is about 45 degrees. The laser radiation beam and the plasma stream move with the same speed with regard to the workpiece. The welding wire 3 is fed continuously.

### System—Example 2

The method of conducting the process in second embodiment of the system shown in FIG. 3 consists in using a welding robot arm with mounted laser head L for welding with wire 3, welding wire feeder 7, and at least two heads A and B of cold atmospheric plasma. The head A is mounted ahead and the head B behind the laser beam. Both heads A and B have adjustable inclination angles, respectively α and β, and distances, respectively d1 and d2, relative to the surface of the material, as well as an adjustable distance from the laser head. This allows first plasma stream A to be focused on the surface of the workpiece 1 in the area of exposure to the laser beam L, and allows second plasma stream B to be focused behind the laser beam L, with the plasma stream B being tangent to or partially overlapping the plasma stream A. Continuous coverage of the treated zone of material with cold plasma is thus ensured. The angle α is about 45 degrees, and the angle β is about 15 degrees. Setting a relatively small angle β extends the area of coverage of the second CAP stream over a longer stretch of the trace 2. The welding wire 3 is fed continuously while the robot arm moves at a programmed speed, which can vary over time.

### System—Examples 3 and 4

In third and fourth embodiments of the system shown in FIG. 4 and FIG. 5, respectively, instead of the welding wire 3 feeder 7, the powder feeders 5 are mounted in the feeding head 4, and the laser head L adapted to powder cladding is used. Metallic, ceramic or metal-ceramic powder, depending on the type of processing, is fed continuously during the welding, cladding, alloying and dispersing processes. In turn, the processes of surface remelting, surface heat and thermo-chemical treatment, laser ablation, surface structuring of materials are carried out without the use of additional materials and in these cases the powder feeder 5 is turned off. In both of these examples, the angles α and β of inclination of the CAP heads equal about 45 degrees.

### System—Example 5

In the fifth embodiment shown in FIG. 6, the system from the fourth example (FIG. 5) was modified in such a way that a universal feeding head was used, in which feeders were installed to supply various materials, fillers included, to the processing site, e.g. welding wire 3, powder 5 or other material 6.

Several examples of machining processes for various metals using the SLCP system are described below.

The SLCP process uses working gases that perform the following functions:
shielding gas guided together with the laser beam,
carrier gas used to transport the working powder,
gas for generating cold plasma in high-frequency discharge.

The type, pressure and flow rates of these gases are the parameters selected for the specificity of given process. In these examples, argon (Ar) was used as the shielding gas and helium (He) was the carrier gas. Argon with a constant flow rate was used as the working gas in the CAP heads.

Argon is used in the laser process to protect the treated area from oxygen and nitrogen from the air. Argon is also used in CAP heads to be ionized with high-frequency radio waves. Note that the term “cold atmospheric plasma” does not mean ionized air. The name originates from that CAP is produced at atmospheric pressure, i.e. pressure close to normal. As mentioned above, the ionized gas in this case is argon.

### Process—Example 1—Welding

GRADE 2 titanium sheets with dimensions of 200×60×6 mm were prepared. The hybrid welding process was carried out using a system in which a continuous disc laser was installed on the robot arm, characterized by the following parameters: maximum power 4 KW, wavelength 1030 nm, beam quality (BPP) 8 mm*mrad. The diameter of the spot on the workpiece is adjustable in a range from 0.2 mm to 6.4 mm.

The light beam emitted by the laser is guided to the working head using an optical fiber with a core diameter of 0.2 mm. This value determines the minimum diameter of the spot on the material obtained in the focal plane of the laser head. Increasing the working distance results in an increase in the spot diameter. This is one of various ways of adjusting the light power density on the material, given by the ratio of power to the square of the spot diameter, with a factor of 4/π.

Two CAP heads with a nominal power of 500 W were also installed, generating streams of cold atmospheric plasma with an ionic temperature not exceeding 60° C., which is illustrated in FIG. 10. The electron temperature is of the order of several thousands kelvins, as evidenced by the white colour of light emitted by the CAP beams leaving the nozzles 8. One of the CAP heads was mounted ahead the laser beam at an angle of 45 degrees, and the other was mounted behind the beam at an angle of 15 degrees to the sheet surface. In both CAP heads, the nozzles 8 had a diameter of 5 mm. The diameter of the streams 9 of cold plasma on the surface of the material was about 20 mm.

Before welding, the edges of the joined titanium sheets were ground with P180 sandpaper and degreased with isopropyl alcohol. The sheets were mounted in the welding device, the prepared edges were adjusted and the sheets secured against movement with clamps. The operating parameters were set as follows: laser power 3000 W, head speed 25 mm/s, power density in the spot 467kW/cm2 , shielding gas flow rate (Ar) 24 l/min. The power of the CAP heads was set at 335 W, the gas (Ar) was fed at a pressure of 1.4 bar, the plasma excitation frequency was 23 kHz.

The process of hybrid welding with the SLCP system consists in simultaneous impacting the materials to be joined with the laser beam and two streams of cold atmospheric plasma. Distance from the laser of the CAP head mounted ahead the laser beam was set so that the stream of cold plasma was focused on the surface of the sheets to be joined, in the area of their exposure to the laser beam. In turn, distance from the laser of the CAP head mounted behind the beam was set so that the stream of cold plasma was focused on the surface of the sheets to be joined, but only tangentially to the spot of the laser beam.

Welding with the use of the SLCP system is shown in FIG. 11. As previously mentioned, the feeding head has been removed to show the configuration of key system components.

For the sake of comparison, a welded joint was made without CAP beams and only with the use of a laser, without changing its operating parameters. The average hardness of the joint made with the use of laser and CAP was 265 HV1 , and was 17% lower than the average hardness of the joint welded only with the laser beam. Microscopic examination revealed neither porosity nor oxides in the hybrid (SLCP) welded joint, whereas they were visible in the laser-only joint.

### Process—Example 2—Cladding

A sheet of S355J 2 steel with dimensions of 200×120×6 mm was prepared. Metallic powder Stellite 6 with an average particle size of 90 μm (micrometers) was used. Chemical composition of Stellite 6 powder: Cr—28.5%, W—4.6%, C—1.2%, Ni—3.0%, Mo—1.5%, Fe—2.0%, Si—1.0%, Co—rest. The hybrid cladding process was performed using the SLCP system configuration as described in example 1, above.

As in the previous example, before proceeding with the powder cladding, the sheet surface was sanded with P180 sandpaper and degreased with isopropyl alcohol. The sheet was mounted in the welding device and secured against movement with clamps. The working parameters were set as follows: laser power 2700 W, head speed 4 mm/s, power density 6.56 kW/cm 2 , shielding gas Ar, shielding gas feeding speed 16 l/min, powder feeding speed 13.9 g/min, carrier gas He for transporting powder, carrier gas flow rate 4 l/min, CAP parameters as in example 1.

The hybrid powder cladding process consisted in simultaneous impacting the treated surface with the laser beam, two CAP streams and Stellite 6 metallic powder. This is shown in FIG. 12, in the version of the device with the feeding head mounted.

To compare, overlay welds were made of the same powder with the use of laser only, without changing its operating parameters. The surface hardness of the overlay made with the laser and CAP was 458 HV1 and was 7.5% lower than the hardness of the overlay made only with the laser. The overlay height was 2.3 mm and was 9% lower, while the overlay width was 8.4 mm and was 24% greater than the width of the overlay made only with the use of a laser. Microscopic examination did not reveal the presence of porosity or cracks in the overlay made by hybrid process.

### Process—Example 3—Alloying

A sheet of S355J2 steel with dimensions of 200×120×6 mm was prepared. Metallic powder Metco 15E with an average particle size of 106 μm (micrometers) was used. Chemical composition of Metco 15E powder: Cr—17.2%, Fe—4.1%, Si—4.1%, B—5.5%, C—1.0%, Ni—the rest. The process of alloying, i.e. fusing powder particles into the substrate material, was carried out using the SLCP system in the configuration described in example 1.

As a standard, before alloying, the sheet surface was sanded with P180 sandpaper and degreased with isopropyl alcohol. The sheet was mounted in the welding device and secured against movement with clamps.

The operating parameters were set as follows: laser power 1500 W, head speed 4 mm/s, power density 3.65 kW/cm2 , shielding gas Ar, shielding gas flow rate 16 l/min, powder feed speed 3.9 g/min, carrier gas He for transporting powder, carrier gas flow rate 6 l/min. CAP parameters were set as in example 1.

The process of hybrid alloying of the material surface consisted in simultaneous impacting the treated surface with the laser beam, two CAP streams, and Metco 15E powder. This is shown in FIG. 12, in the version of the device with the feeding head mounted.

Hardness of the alloyed surface was 1049 HV1 and was 2.7 times higher than hardness of the base material. The Metco 15E powder particles were embedded to a depth of 0.9 mm. Microscopic examination did not reveal any porosity or cracks in the treated material.

### Process—Example 4—Dispersing

A GRADE 2 titanium sheet with dimensions of 200×120×3 mm and a powder composed of 95% ZrO2 and 5% Y2O3, with average particle size of 90 μm (micrometers) were prepared. The process of dispersing, i.e. fusion of non-metallic powder particles into the substrate material, was carried out using the SLCP system described in example 1, in the same configuration.

Likewise in previous examples, before proceeding with dispersing, the sheet surface was sanded with P180 sandpaper and degreased with isopropyl alcohol. The sheet was mounted in the welding device and secured against movement with clamps.

The operating parameters were set as follows: laser power 1500 W, head speed 4 mm/s, power density 3750 kW/cm2, shielding gas Ar, shielding gas flow rate 16 l/min, powder feed speed 1.49 g/min, gas carrier He, carrier gas feed rate 4 l/min. CAP parameters were again set as in example 1.

The process of hybrid surface dispersing of the material consisted in simul taneous impacting the treated surface with the laser beam, two CAP streams, and ZrO2+Y2O3 powder.

Hardness of the doped surface was 646 HV1 and increased 4.5 times compared to hardness of the base material. ZrO2 and Y2O3 particles were embedded to a depth of 2.1 mm. Microscopic examination did not reveal any porosity or cracks in the treated material.

For the sake of comparison the inventors attempted to carry out the laser dispersing of ZrO2+Y2O3 powder on the surface of GRADE 2 titanium sheet, but without the use of CAP. Regardless of settings of the laser operating parameters, various trials proved such a process is not useful. If the process is not supported with CAP, the effect of fusion of ZrO2 and Y2O3 powder particles into the GRADE 2 titanium substrate material was not obtained.

### Process—Example 5—Surface Remelting

A sheet of S355J2 steel measuring 200×120×6 mm was prepared, with a coating flame sprayed with the use of acetylene as the working gas and Metco 36C powder containing 35% TC (tungsten carbide) and a nickel-based metal matrix. Thickness of the coating was 790 μm (micrometers) and its hardness was 389 HV1. As before, the hybrid surface remelting process was carried out using the SLCP system described in example 1, in the same configuration.

Before starting remelting, the coated sheet surface was degreased with isopropyl alcohol and the sheet was mounted in the welding device and secured against movement with clamps.

The operating parameters were set as follows: laser power 2000 W, head speed 4 mm/s, power density 4.86 kW/cm2, shielding gas Ar, shielding gas flow rate 16 l/min. CAP parameters as in example 1.

The process of hybrid remelting of the surface with applied coating consisted in simultaneous impacting the treated surface with the laser beam and two CAP streams. The powder feeder has been disabled. The resulting surface fusion effect is shown in close-up view in FIG. 13 after completing the treatment. The structure of the post-process trace is visible.

For comparison, remeltings were made using the laser operating with the same parameters, but without CAP. Hardness of the surface remelted with the use of both laser and CAP was 789 HV1 and was more than twice (i.e. over 100%) higher than hardness of primary flame sprayed coating, and by 17% higher than hardness of the surface remelted only by laser. In both cases of remelting, a change in fusion of the coating material to the substrate material from adhesive to metallurgical was obtained.

### Process—Example 6—Surface Heat Treatment

A sheet of DEF STAN 10-13/4 steel with dimensions of 80×50×10 mm was prepared. The material hardness was 396 HV1. The hybrid surface heat treatment process was carried out using the SLCP system in the following configuration: a 4 KW disk laser with a powder hardfacing feeding head mounted on a robot arm, and one CAP head of power 500 W attached to the laser head. The CAP head was mounted ahead the laser beam, at an angle of 450 to the sheet surface. The nozzle in the CAP head had a diameter of 5 mm.

Before starting the surface heat treatment, the sheet surface was degreased with isopropyl alcohol. The sheet was mounted in the welding device and secured against movement with clamps.

The laser operating parameters were set as follows: power 1200 W, head speed 4 mm/s, power density 2.95 kW/cm2, shielding gas Ar, shielding gas flow rate 16 l/min. Again, CAP parameters were as in example 1.

The process of hybrid surface heat treatment consisted in the simultaneous impacting the the treated surface with the laser beam and one CAP stream. The powder feeder in the powder feed head has been disabled.

Hardness of the surface heat treated with the use of a laser and cold atmospheric plasma was 787 HV1 and was about twice as high as hardness of the substrate material. Besides, no visible traces of oxidation were found on the surface of treated material.

FIG. 14 shows an example of application of the SLCP system to surface heat treatment with two CAP heads engaged.

The embodiments and uses of the invention described above are not limited to the use of a laser as a radiation source. As mentioned above, other sources of electromagnetic radiation, especially optical radiation, e.g. a laser diode, as well as a source of corpuscular radiation can be used in the invention.

It should be noted that the invented system can also be used to treat other substrates, including non-metallic ones. Due to the ionic temperature of CAP, which is lower than the melting point of many commonly used plastics, such as polyethylene and its derivatives (PE, PET, PEX), polypropylene (PP), polyurethane (PU), polyvinyl chloride (PVC) and others, the SLCP system offers new possibilities for processing plastics and other non-metallic materials as well as composites.

### REFERENCES

1. T. Diebold, C. Albright: Weld. J., 1984, 63, (6), 18-24.
2. C. Maier: Laser beam—arc hybrid welding, PHD thesis, RWTH, Aachen, Germany, 1998, D 82(1998 , Aachen, ShakerVerlag).
3. V S. Gvosdetsky, I. V. Krivtsun, M. I. Chizhenko, L. M. Yarinich: Laser—arc discharge: theory and applications; Welding and Surfacing Reviews; 1995, New York, Harwood Academic Publishers.
4. I. V. Krivtsun, M. I. Chizhenko: Paton Weld. J., 1997, 9, (1), 19-26.
5. D. M. Gureev, A. E. Zaikin, A. B. Zolotarevsky: Trans. Phys. Inst. USSR Acad. Sci., 1989, 198, 41p 61.
6. J. Matsuda, A. Utsumi, M. Katsumura, M. Hamasaki, S. Nagata: Joining Mater., 1988, 1, (1), 31-34.
7. E. Beyer, U. Dilthey, R. Imhoff, C. Maier, J. Neuenhahn, K. Behler: Proc. ICALEO '94; 1994, Orlando, FL, Laser Institute of America.
8. J. Biffin, R. Walduck: Proc. Conf. ‘Eurojoin II’, Florence, Italy, 1994, AIM, 295-304.
9. J. Clarke, W. Steen: Proc. Conf. ‘Laser '78’, London, March 1978, International Engineers Digest, Vol. 16, 11-30.

### REFERENCE NUMBERS IN THE DRAWINGS

1—treated material (substrate, workpiece)
2—trace of treatment
3—welding wire
4—feeding head
5—powder feeder
6—additional material feeder
7—wire feeder
8—nozzle of CAP source (CAP head)
9—stream (jet) of CAP emitted from the nozzle
A, A1, A2—first CAP source arranged ahead the beam of radiation
α—angle of inclination of the nozzle axis of first CAP head to the surface of the treated material
d1—distance of the nozzle outlet of first CAP head from the surface of the treated material
B, B1, B2—second CAP head placed behind the beam of radiation
β—angle of inclination of the nozzle axis of second CAP head to the surface of the treated material
d2—distance of the nozzle outlet of second CAP head from the surface of the treated material
L—radiation source
S—optical system focusing and guiding the radiation beam
SF—optical system focusing and guiding the radiation beam through the optical fiber
F—optical fiber

1. A system for processing or joining materials, comprising a radiation source (L) generating a beam of radiation with flux density enabling to obtain a change in the form or physical properties of given material and directed at the processed material (1), and at least one source of cold atmospheric plasma (A, A1, A2, B, B1, B2) directing a stream (9) of cold atmospheric plasma to an area of the material (1) exposed to the beam from the radiation source (L), or partially or entirely onto a trace (2) of treatment, wherein the system has a feeding head (4) comprising a wire feeder (7) of the welding wire (3) and/or a powder feeder (5), in particular a feeder of metallic, ceramic or metal-ceramic powder, and an additional material feeder (6), in particular for the material in the form of powder or gas, or liquid.

2. The system according to claim 1 characterized in that the cold atmospheric plasma source (A) is mounted coaxially with the radiation source (L) and directs the cold atmospheric plasma stream (9) onto the area of material (1) exposed to the beam from the radiation source (L), so that the beam of radiation emitted by the radiation source (L) is surrounded by the stream (9) of cold atmospheric plasma.

3. The system according to claim 1, characterized in that at least one source of cold atmospheric plasma (A, A1, A2) is mounted ahead the radiation source (L) and directs the stream (9) of cold atmospheric plasma to the area of material (1) exposed to the beam from the radiation source (L), which leaves a trace (2) of treatment during processing.

4. The system according to claim 1, characterized in that at least one source of cold atmospheric plasma (B, B1, B2) is mounted behind the radiation source (L) and directs the stream (9) of cold atmospheric plasma to the area of material (1) exposed to the beam from the radiation source (L), or partially or entirely onto the trace (2) of treatment behind the radiation source (L).

5. The system according to claim 2, characterized in that the source of cold atmospheric plasma (A) has an adjustment of distance of the nozzle (8) outlet from the surface of treated material (1).

6. The system according to claim 3, characterized in that the source of cold atmospheric plasma (A, A1, A2, B, B1, B2) has an adjustment of distance (d1, d2) of the nozzle (8) outlet from the surface of treated material (1), and it has an adjustment of angle (α, β) between the axis of the nozzle (8) and the surface of the material (1), as well as preferably it has an adjustment of distance from the radiation source (L).

7-9. (canceled)

10. The system according to claim 1, characterized in that the additional material feeder (6) is suitable to supply a shielding gas.

11. (canceled)

12. The system according to claim 1, characterized in that the source of cold atmospheric plasma (A) coaxial with the radiation source (L) is mounted in the feeding head (4).

13. The system according to claim 1, characterized in that between the radiation source (L) and the material (1), above or in the feeding head (4) itself, a focusing and beam-guiding system is mounted, preferably with an adjustment of distance from the surface of treated material (1), in particular, it is an optical system(S) focusing and guiding the beam of radiation, preferably by means of an optical fiber (F).

14. The system according to claim 2, characterized in that between the radiation source (L) and the cold atmospheric plasma source (A) coaxial with the radiation source (L) a system is mounted forming a parallel beam of radiation with a cross-sectional area smaller than the cross-sectional area of the stream (9) of cold atmospheric plasma, preferably with an adjustment of distance from the surface of treated material (1), in particular, it is an optical system (SF) focusing and guiding the beam of radiation, preferably by means of an optical fiber (F) placed along the axis of the source of cold atmospheric plasma (A), and/or through an optical channel.

15. The system according to claim 14, characterized in that the radiation source (L) is a laser, in particular a disk laser or a laser diode.

16. The system according to claim 15, characterized in that the radiation source (L) emits radiation in a range from 200 nm to 15 μm, preferably infrared radiation, preferably with a wavelength of 1064 nm.

17. The system according to claim 16, characterized in that the radiation source (L), the system focusing and guiding the radiation beam (S, SF), the source of cold atmospheric plasma (A, A1, A2, B, B1, B2) and the feeding head (4) are placed on an arm of a robot, preferably numerically controlled and executing a programmed treatment process.

18. A method of processing or joining materials using the system for processing or joining materials, in which a beam of radiation with flux density enabling a change in the form or physical properties of given material is directed from a radiation source (L) onto the processed material (1), wherein by means of at least one source of cold atmospheric plasma (A, A1, A2, B, B1, B2) a stream (9) of cold atmospheric plasma is generated which is then directed to the area of material (1) exposed to the beam from the radiation source (L), or partially or entirely onto a trace (2) of treatment, and wherein the system used has a feeding head (4) comprising a wire feeder (7) of the welding wire (3) and/or a powder feeder (5), in particular a feeder of metallic, ceramic or metal-ceramic powder, and an additional material feeder (6), in particular for the material in the form of powder or gas, or liquid.

19. The method according to claim 18, wherein the source of cold atmospheric plasma (A, A1, A2) is mounted ahead the radiation source (L) or in its axis, and the stream (9) of cold atmospheric plasma is directed onto the area of material (1) exposed to the beam from the radiation source (L) which during treatment leaves the trace (2) of treatment, and preferably the source of cold atmospheric plasma (B, B1, B2) is mounted behind the radiation source (L) and the stream (9) of cold atmospheric plasma is directed to the area of material (1) exposed to the beam from the radiation source (L), or partially or entirely onto the trace (2) of treatment behind the radiation source (L), and optionally, a distance (d1, d2) of the nozzle (8) outlet from the surface of treated material (1) and an angle (α, β) between the axis of the nozzle (8) and the surface of the material (1), and preferably a distance of the cold atmospheric plasma source (A, A1, A2, B, B1, B2) from the radiation source (L) are set.

20. An application of the system for processing or joining materials and the method for treatment or joining of metallic, non-metallic or composite materials, characterized in that in order to carry out the processes of welding, cladding, alloying, dispersing, surface remelting or surface heat treatment with the use of the radiation source (L), preferably an infrared radiation source, at least one stream (9) of cold atmospheric plasma is directed onto the treated material (1).
